(19) United States
(12) Patent Application Publication
(10) Pub. No.: US 2004/0251699 A1
(43) Pub. Date: Dec. 16, 2004

(54) Carpet retractor

(76) Inventors: Drue Kehl, Murray, UT (US); Gordon Case, South Jordun, UT (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/867,339

(22) Filed: Jun. 14, 2004

Related U.S. Application Data
(60) Provisional application No. 60/478,317, filed on Jun. 13, 2003.

(51) Int. Cl. B65G 7/00

(52) U.S. Cl. 294/15

(57) ABSTRACT

The invention involves a carpet retractor for moving rolls of carpets, pipes, conduit and other tubular elements. The carpet retractor includes an elongate member to which the other components of the carpet retractor are coupled, a plurality of gripping members adapted to engage the inner surface of a roll of carpet, and an engagement mechanism configured to actuate a plurality of gripping members so as to facilitate the movement of rolls of carpet.

### CROSS-REFERENCE TO RELATED APPLICATIONS

This application claims priority to U.S. patent application Ser. No. 60/478,317, filed Jun. 13, 2003, and entitled CARPET RETRACTOR, which is incorporated herein by reference in its entirety.

### BRIEF SUMMARY OF THE INVENTION

The present invention relates to a carpet retractor which allows user to quickly and efficiently move a roll of carpet when a single end of the carpet roll is exposed. The carpet retractor can also facilitate displacement of carpet rolls using a forklift or other equipment. The carpet retractor includes an elongate member, a plurality of gripping members, and an extension mechanism.

According to one aspect of the present invention, the plurality of gripping members are coupled to an upper portion of the elongate member. The gripping members can be selectively extended or retracted to engage or disengage the inner surface of a roll of carpet. The extension mechanism facilitates extension and retraction of the gripping members. According to one aspect of the present invention, the extension mechanism includes a collar, a cable, a collar biasing component, and multiple gripping member biasing components.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of the carpet retractor.

FIG. 2 illustrates an enlarged view of the carpet retractor as shown in FIG. 1 illustrating the upper and lower portion of the carpet retractor.

FIG. 3 shows a cut-away view of the upper portion of the carpet retractor.

FIG. 4a illustrates the gripping members of the carpet retractor in a retracted position.

FIG. 4b is a front view of the carpet retractor illustrating the gripping members in a retracted positioned inside a roll of carpet.

FIG. 5a shows the gripping members of the carpet retractor in an extended position.

FIG. 5b is an enlarged view of an engagement surface of the gripping members.

FIG. 5c illustrates the gripping members of the carpet retractor in an extended position engaging the inside of a carpet roll.

FIG. 6 shows an isometric view of the carpet retractor inside a roll of carpet.

### DETAILED DESCRIPTION OF THE PREFERRED EMBODIMENTS

The present invention is directed to a carpet retractor adapted to move rolls of carpet. The principles of the invention, however, are not limited to rolls of carpet. It will be understood that, in light of the disclosure, the carpet retractor herein can be successfully used in connection with other types of rolled material, or other tubular mechanisms and structures.

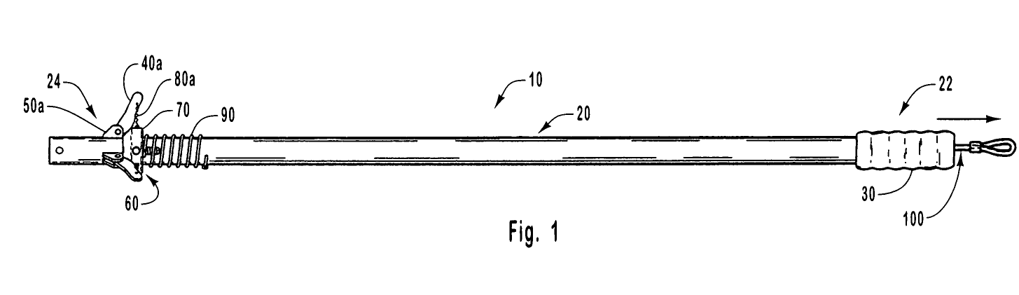

FIG. 1 is a perspective view illustrating a carpet retractor 10 according to one aspect of the invention. The carpet retractor 10 is adapted to allow a user to quickly and efficiently move carpet roll 110 by engaging the internal surface of a tube on which carpet roll 110 is rolled. This allows carpet roll 110 to be moved even when only a single end of carpet roll 110 is exposed. Additionally, carpet roll retractor 10 facilitates removal of carpet roll 110 utilizing a forklift, unloading machine, or other equipment. In the illustrated embodiment, carpet retractor 10 comprises an elongate member 20, gripping members 40a-c, and an extension mechanism 60.

Elongate member 20 provides the framework on which additional components of carpet retractor 10 are positioned. In the illustrated embodiment, elongate member 20 comprises a hollow cylindrical member comprised of metal, plastic, or wooden tube. Elongate member 20 comprises an elongate member lower portion 22 and an elongate member upper portion 24. A variety of types and configurations of elongate members can be utilized without departing from the scope and spirit of the invention. For example, in one embodiment, the elongate member comprises a solid support base on which additional components of the carpet retractor are positioned.

Gripping members 40a-c are coupled to elongate member upper portion 24. Gripping members 40a-c are adapted to selectively engage the inner surface of a tube on which carpet roll 110 is rolled. Gripping members 40a-c are configured to engage a roll 110 of carpet to allow a user to move roll 110 of carpet. In the illustrated embodiment, three gripping members 40a-c are provided as part of carpet retractor 10. However, any number of gripping members 40a-c can be utilized without departing from the scope and spirit of the invention. For example, in an alternative embodiment, four gripping members 40a-c are provided as part of carpet retractor 10. In the illustrated embodiment, gripping members 40a-c comprise rigid members hingedly coupled to the elongate member upper portion 24. A variety of types and configurations of gripping members 40a-c can be utilized without departing from the scope and spirit of the invention. For example, in an alternative embodiment, gripping members 40a-c are hollow, rigid, lightweight composite projections. In another embodiment, the gripping members comprise solid projection members made of metal, plastic, or wood. Gripping members 40a-c are one example of extendable members.

In the illustrated embodiment, gripping members 40a-c are coupled to elongate member 20 utilizing gripping member brackets 50a-c. Gripping member brackets 50a-c comprise a hinge-type pin joint. Nevertheless, a variety of types and configurations of mechanisms can be utilized to couple gripping members 40a-c to the elongate member. For example in one embodiment, gripping member brackets 50a-c comprise a ball and socket joint. In alternative embodiment, gripping member brackets 50a-c comprise a compliant member joint.

In the illustrated embodiment, extension mechanism 60 is coupled to elongate member upper portion 24 adjacent gripping members 40a-c. Extension mechanism 60 allows a user to selectively extend and retract gripping members 40a-c so as to engage and disengage a carpet roll 110 to be moved. In the illustrated embodiment, extension mechanism 60 comprises a collar 70, a collar-biasing component 90, a plurality of gripping member-biasing components 80a-c, and a cable 100. As will be appreciated by those skilled in the art, a variety of types and configurations of extensions mechanisms can be utilized without departing from the scope and spirit of the present invention. For example, in one embodiment the extension mechanism is directly coupled to the gripping members. In an alternative embodiment, the extension mechanisms utilizes intersecting elements connected to the gripping members to extend and retract the gripping members.

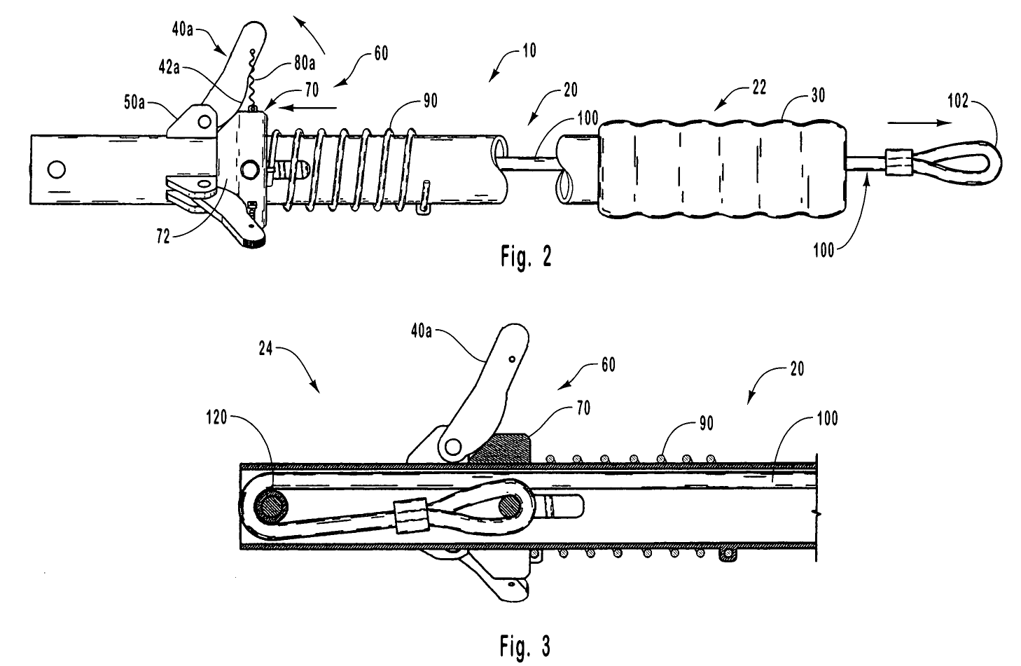

FIG. 2 illustrates the manner in which extension mechanism 60 extends and retracts gripping members 40a-c. Extension mechanism 60 comprises a collar 70, a collar-biasing component 90, a plurality of gripping member-biasing components 80a-c, and a cable 100. In the illustrated embodiment, collar 70 is slidably coupled to the elongate member upper portion 24 and co-axially orientated therewith. Collar 70 is configured to actuate gripping members 40a-c so as to facilitate the movement of a carpet roll 110. The gripping members 40a-c are actuated when a contact surface 72 of collar 70 engages the curvilinear profile 42a-c of gripping members 40a-c thus forcing gripping members 40a-c to extend outward. As will be appreciated by those skilled in the art, a variety of mechanisms for extending the gripping members can be utilized without departing from the scope and spirit of the present invention. Collar 70 is one example of an extension flange.

In the illustrated embodiment, elongate member 20 houses cable 100. When a user pulls an exposed engagement portion 102 of cable 100 collar 70 moves towards gripping member brackets 50a-c. Collar 70 contacts the curvilinear profile 42a-c of gripping members 40a-c extending gripping members 40a-c. When a user relaxes the tension on cable 100, collar-biasing component 90 urges collar 70 in the direction of elongate member lower portion 22. As collar-biasing component 90 urges collar 70 in the direction of elongate member lower portion 22, gripping member-biasing. components 80a-c retract gripping members 40a-c.

FIG. 3 is a cross-sectional view of elongate member upper portion 24 illustrating the manner in which cable 100 facilitates extension and retraction of gripping members 40a-c. In the illustrated embodiment, elongate member 20 houses cable 100. Cable 100 is routed from collar 70 towards elongate member upper portion 24 where it is positioned over a roller bearing 120. Cable 100 continues back through elongate member 20 extending from elongate member-lower portion 22.

Cable 100 is configured to actuate collar 70 and gripping members 40a-c causing extension of gripping members 40a-c so as to engage the inner surface 112 of a carpet roll 110 or other tubular element with which carpet retractor 10 is utilized. A variety of types and sizes of cables can be used without departing from the scope and spirit of the invention. Additionally, a variety of mechanisms can be utilized in place of roller bearing to facilitate proper actuating of collar 70 when a user pulls cable 100.

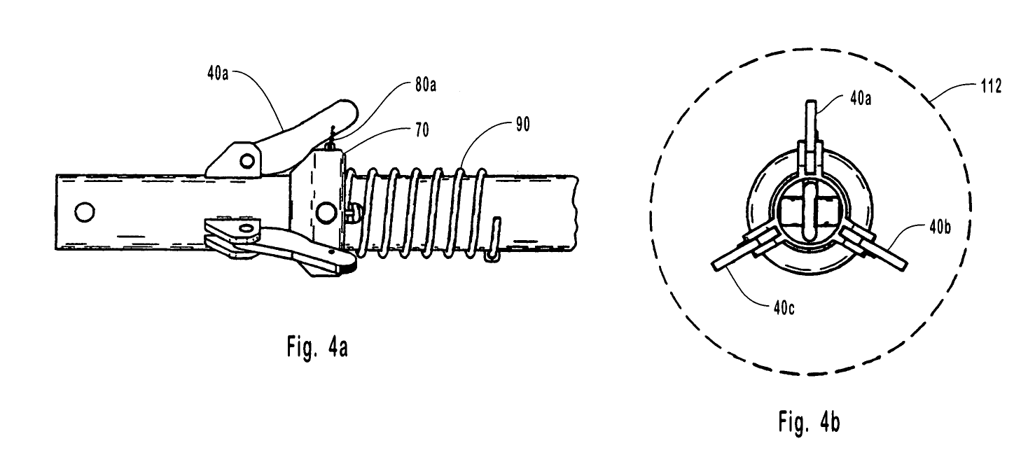

FIG. 4a and FIG. 4b illustrate carpet retractor 10 in a disengaged or retracted orientation. Collar-biasing component 90 is coupled to collar 70 and elongate member 20. Collar-biasing component 90 influences collar 70 so as to facilitate retraction of gripping members 40a-c allowing the user to withdraw carpet retractor 10 from carpet roll 110. As previously discussed, when a user relaxes the pull on cable 100, collar-biasing component causes collar 70 to move in the direction of elongate member lower portion 22. In the illustrated embodiment collar-biasing component comprises a spring. As will be appreciated by those skilled in the art, a variety of types and configurations of collar-biasing components 90 can be utilized without departing from the scope and spirit of the present invention. For example, in an alternative embodiment, the collar-biasing component comprises an elastomeric material such as a rubberized or compressible foam flange.

In the illustrated embodiment, a plurality of gripping member-biasing components 80a-c are coupled to gripping members 40a-c and collar 70. The gripping member-biasing components 80a-c facilitate retraction of gripping members 40a-c. By allowing the user to retract gripping members 40a-c, gripping member-biasing components 80a-c allow the user to reposition or remove carpet retractor 10 relative to the inside carpet roll 110. While gripping member-biasing components 80a-c comprise wire members in the illustrated embodiment, a variety of types and configurations of gripping member biasing components can be utilized. Additionally, a variety of types and configurations of mechanisms can be utilized to retract gripping members 40a-c without departing from the scope and spirit of the present invention. For example, in one embodiment a plurality of resilient members are utilized. In alternative embodiment, the collar mechanism is adapted to directly retract the gripping members 40a-c. In yet another alternative embodiment, spring mechanisms or cable mechanisms are utilized. While in yet another embodiment, a plurality of hinged retraction mechanisms are coupled between the gripping members and the collar mechanism to retract gripping members 40a-c.

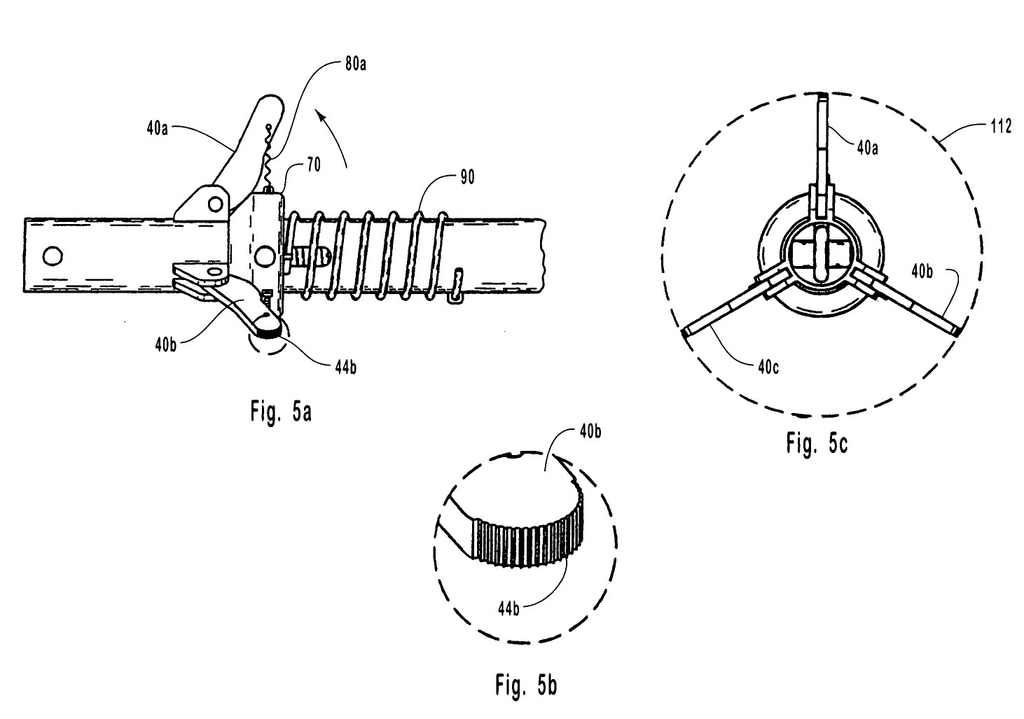

FIGS. 5a, FIG. 5b, and FIG. 5c illustrate carpet retractor 10 in an extended orientation. As previously mentioned, a user extends gripping members 40a-c utilizing exposed engagement portion 102 of cable 100. Cable 100 displaces collar 70 allowing contact surface 72 to engage curvilinear profiles 42a-c of gripping members 40a-c. This results in the extension of gripping members 40a-c. As gripping members 40a-c extend outward, engagement surface 44a-c of gripping member 40a-c contacts the inner surface 112 of the carpet roll 110 causing engagement therewith. By contacting the inner surface 112 of carpet roll 110, sufficient friction is created to allow a user to selectively move carpet roll 110.

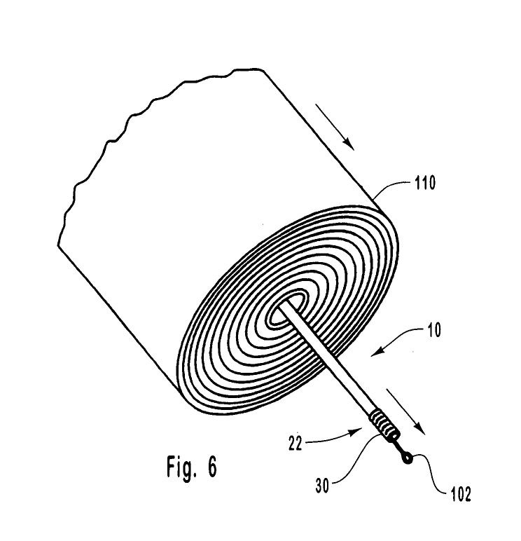

As shown in FIG. 6, carpet retractor 10 allows a user to move carpet roll 110. The user moves carpet roll 110 by inserting carpet retractor 10 into roll 110, extending gripping members 40a-c so as to engage the internal surface of carpet roll 110, and then pulling exposed engagement portion 102 of cable 100 or using a handle grip coupled to elongate member lower portion 22 to slide carpet roll 110. As will be appreciated by those skilled in the art, as the user begins to move carpet roll 110, the force required to move carpet roll 110 strengthens the engagement by gripping members 40a-c on the internal surface of carpet roll 110.

A method of utilizing carpet retractor 10 to move a carpet roll 110 will now be described. The user inserts carpet retractor 10 in a retracted orientation into carpet roll 110. Once the carpet retractor 10 is positioned in carpet roll 110, the user actuates the gripping members 40a-c by pulling the exposed engagement portion 102 of the cable 100. This pulling action causes the collar 70 to contact curvilinear portions 42a-c of the gripping members 40a-c. This causes the gripping members 40a-c to extend outward. The user pulls the exposed engagement portion 102 of cable 100 until gripping members 40a-c extend sufficiently to engage the inner surface 112 of carpet roll 110. Once gripping members 40a-c engage inner surface 112 of carpet roll 110, the user can then manipulate handle grip 102 or exposed engagement portion 112 of cable 110 to displace carpet roll 110. To disengage carpet retractor 10 from carpet roll 110, the user releases the tension on exposed engagement portion 102 of cable 100 facilitating retraction of gripping members 40a-c.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A apparatus configured to move tubular elements such as carpet rolls, pipes, and conduit, the apparatus comprising;
an elongate member;
a plurality of extendable members linked to the elongate member, the one or more extendable members adapted to engage the inner surface of a tubular element, wherein the plurality of extendable members provide sufficient force on the tubular element to allow a user to displace the tubular element;
an extension flange coupled to the elongate member, wherein one or both of the extension flange and the gripping members move relative to one another to selectively extend and or retract the gripping members;
a cable member coupled to the extension flange, the cable member configured to allow a user to selectively extend and or retract the plurality of gripping members.

2. A apparatus configured to move tubular elements such as carpet rolls, pipes, and conduit, the apparatus comprising;
an elongate member;
a plurality of extendable members linked to the elongate member, the one or more extendable members adapted to engage the inner surface of a tubular element, wherein the plurality of extendable members provide sufficient force on the tubular element to allow a user to displace the tubular element;
an extension flange coupled to the elongate member, wherein one or both of the extension flange and the gripping members move relative to one another to selectively extend and or retract the gripping members;
a cable member coupled to the extension flange, the cable member configured to allow a user to selectively extend and or retract the plurality of gripping members; and
a biasing mechanism coupled to the extension flange, the biasing mechanism allowing retraction of the plurality of gripping members.

3. An carpet retractor apparatus configured to move carpet rolls, the carpet retractor apparatus comprising;
an elongate member;
a plurality of gripping members linked to the elongate member, the one or more extendable members adapted to engage the inner surface of a carpet tube on which a roll of carpet is positioned, wherein the plurality of gripping members provide sufficient force on the carpet tube to allow a user to displace the roll of carpet;
an extension flange coupled to the elongate member, wherein the extension flange moves to selectively extend and or retract the gripping members;
a cable member coupled to the extension flange, the cable member configured to allow a user to selectively extend and or retract the plurality of gripping members; and
a biasing mechanism coupled to the extension flange, the biasing mechanism allowing retraction of the plurality of gripping members.

4. A carpet retractor apparatus configured to move carpet rolls, the carpet retractor apparatus comprising:
an elongate member;
a plurality of gripping members coupled to the elongate member, the plurality of gripping members adapted to engage the inner surface of a carpet tube on which a roll of carpet is positioned, wherein the plurality of gripping members provide sufficient force on the carpet tube to allow a user to displace the roll of carpet;
a collar linked to the elongated member, wherein the collar engages the plurality of gripping members to selectively extend and/or retract the plurality of gripping members;
a cable member linked to the collar, the cable member configured to allow the user to displace the collar, wherein the collar selectively extends and or retracts the plurality of gripping members;
a spring linking the collar to the elongate member, the spring providing a bias for the collar thereby facilitating extension and retraction of the plurality of gripping members
a biasing element linking the collar to the plurality of gripping members, the biasing element facilitating retraction of the gripping members.
